(19) United States
(12) Patent Application Publication
(10) Pub. No.: US 2016/0279842 A1
(43) Pub. Date: Sep. 29, 2016

(54) MANUFACTURING STESP FOR HAND TOOL

(71) Applicant: Yao-Lin Cho, Taichung City (TW)

(72) Inventor: Yao-Lin Cho, Taichung City (TW)

(21) Appl. No.: 14/666,256

(22) Filed: Mar. 23, 2015

(51) Int. Cl. B29C 45/14; B05D 1/00; C25D 7/00; B25B 23/16; B25G 1/10

(52) U.S. Cl. CPC B29C 45/14; B25B 23/16; B25G 1/105; C25D 7/00; B05D 1/007; B05D 2350/60; B29L 2031/283

(57) ABSTRACT

Manufacturing steps for manufacturing a hand tool include a step of setting a base part which has a handle end and a driving end; a step of molding: coating plastic to the base part by way of plastic injection molding to form the base part into an initial product which has a handle portion and a driving head, an installation hole defined through the driving head; a step of coating: electro-coating outer surface of the plastic of the initial produce, and a step of assembly: assembling a driving member in the installation hole by using fixing members so as to obtain a final product.

### BACKGROUND OF THE INVENTION

1. Fields of the invention

The present invention relates to manufacturing steps, and more particularly, to manufacturing steps for manufacturing a hand tool.

2. Descriptions of Related Art

The conventional hand tools comprise a driving head and a handle which extends from the driving head. In order to have a strong strength so as to be durable even being operated roughly, the hand tools usually made by steel. The steel is expensive than other material and usually are treated by the following steps which are straightening, cutting, heat treatment, pressing and forging. The steps are complicated and involve different equipment. The steel is treated by way of cold forging after step of hot forging, and the steel is then cut and milled to form the basic product with rough shape of the hand tool. The basic product is then treated by steps of heat treatment, polishing and electro-coating, all of the steps are expensive and lower its competition in the market.

Some manufacturers use Zinc to replace steel because Zinc is less expensive. However, the cost for using the Zinc to make the hand tool is still high.

Furthermore, the smaller of the size of the hand tools, the lower price they have, nevertheless, the smaller hand tools have to be made by the same steps. Besides, the smaller hand tools are easily deformed during the step of heat treatment, some of the handles of the tools may deform over 180 degrees. Extra steps are required to correct the handles and this increases the cost.

The present invention intends to provide manufacturing steps for manufacturing a hand tool so as to eliminate the shortcomings mentioned above.

### SUMMARY OF THE INVENTION

The present invention relates to manufacturing steps for manufacturing a hand tool, and the steps comprise:

a step of setting a base part: a baes part made by hard material being set and having a handle end and a driving end;

a step of molding: coating plastic to the base part by way of plastic injection molding to form the base part into an initial product which has a handle portion and a driving head, the handle portion located corresponding to the handle end, the driving head located corresponding to the driving end, an installation hole defined through the driving head;

a step of coating: electro-coating outer surface of the plastic of the initial produce, and

a step of assembly: assembling a driving member in the installation hole, the driving member being positioned in the installation hole by using fixing members so as to obtain a final product.

The primary object of the present invention is to provide manufacturing steps for manufacturing a hand tool, the steps does not need steps of sintering, powder metallurgy, heat treatment and hot forging so as to save the manufacturing cost.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the steps of the present invention;

FIG. 2 is a perspective view to show the base part in the step of setting a base part of the present invention;

FIG. 3 is a perspective view to show the base part is to be coated before the step of molding;

FIG. 4 is a perspective view to show the base part is coated with plastic after the step of molding;

FIG. 5 is an exploded view to show the initial product and the driving member and the fixing members;

FIG. 6 is a perspective view to show the final product of the present invention, and

FIG. 7 is a cross sectional view, taken along line VII-VII in FIG. 6.

### DETAILED DESCRIPTION OF THE PREFERRED EMBODIMENT

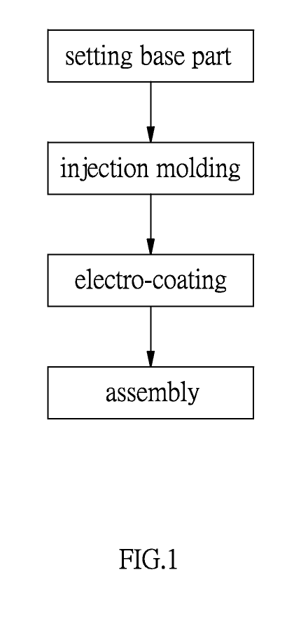

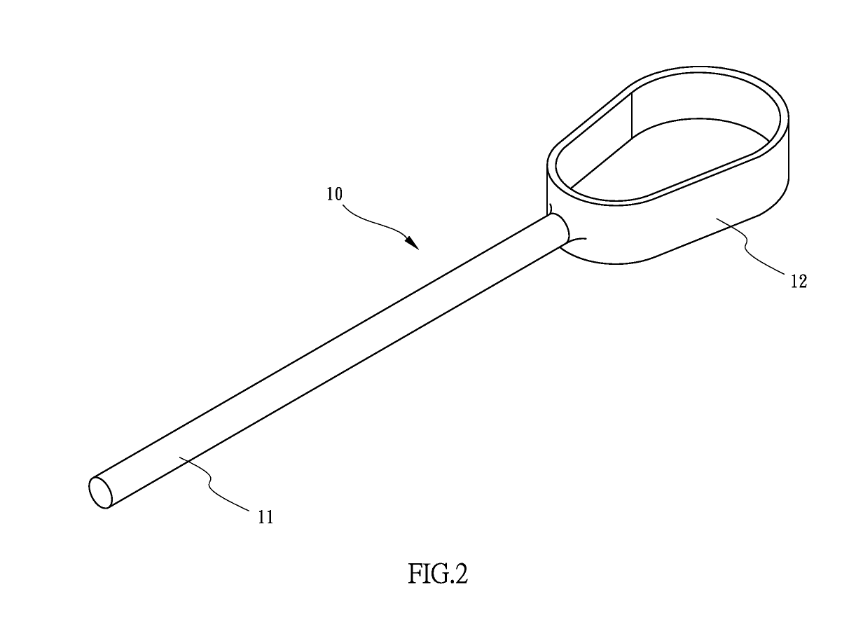

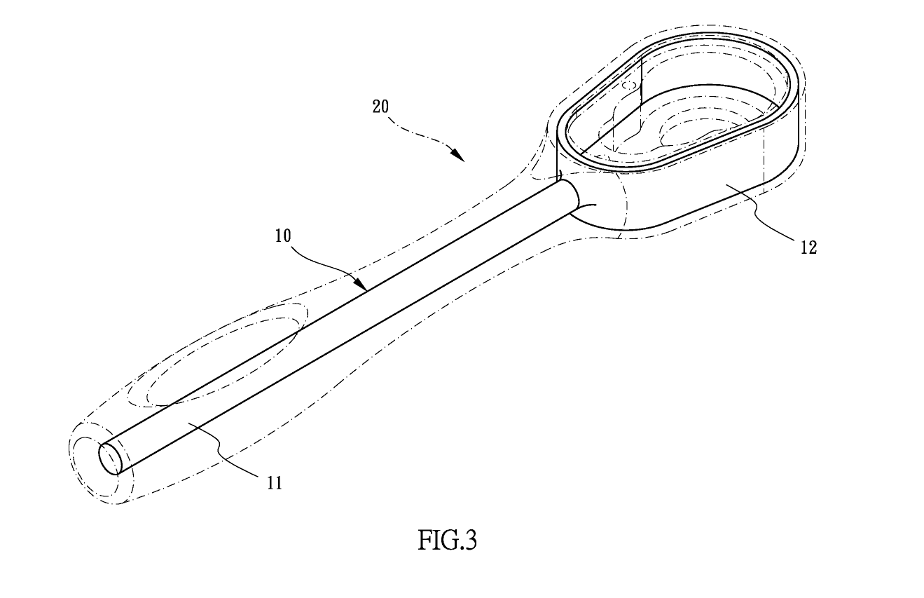

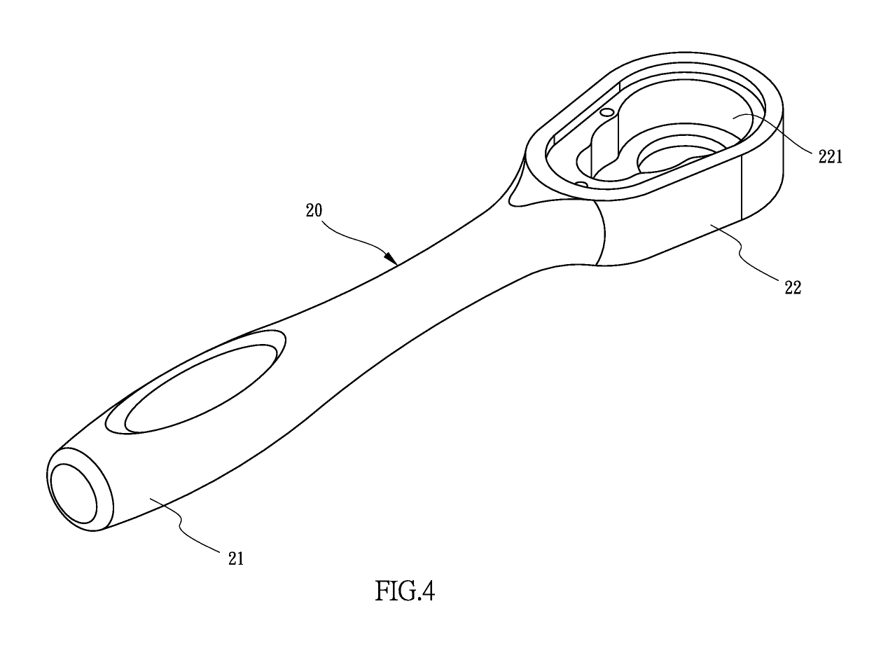

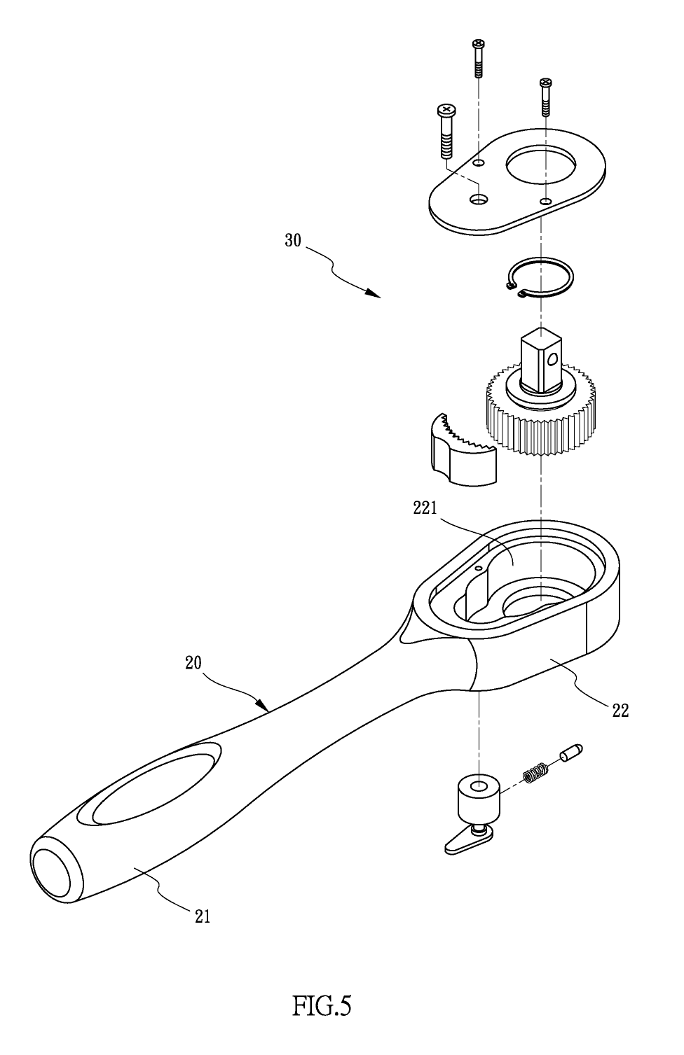

Referring to FIGS. 1 to 5, the Manufacturing steps for manufacturing a hand tool, comprising:

A step of setting a base part. A baes part 10 is made by hard material and has a handle end 11 and a driving end 12.

A step of molding. A plastic injection molding machine us used to coat plastic onto the base part 10 by way of plastic injection molding to form the base part 10 into an initial product 20 which has a handle portion 21 and a driving head 22. The handle portion 21 is located corresponding to the handle end 11, and the driving head 22 is located corresponding to the driving end 12. An installation hole 221 is defined through the driving head 22.

A step of coating. The process of electro-coating is applied to the outer surface of the plastic of the initial produce 20 so as to make better outer appearance of the initial product 20.

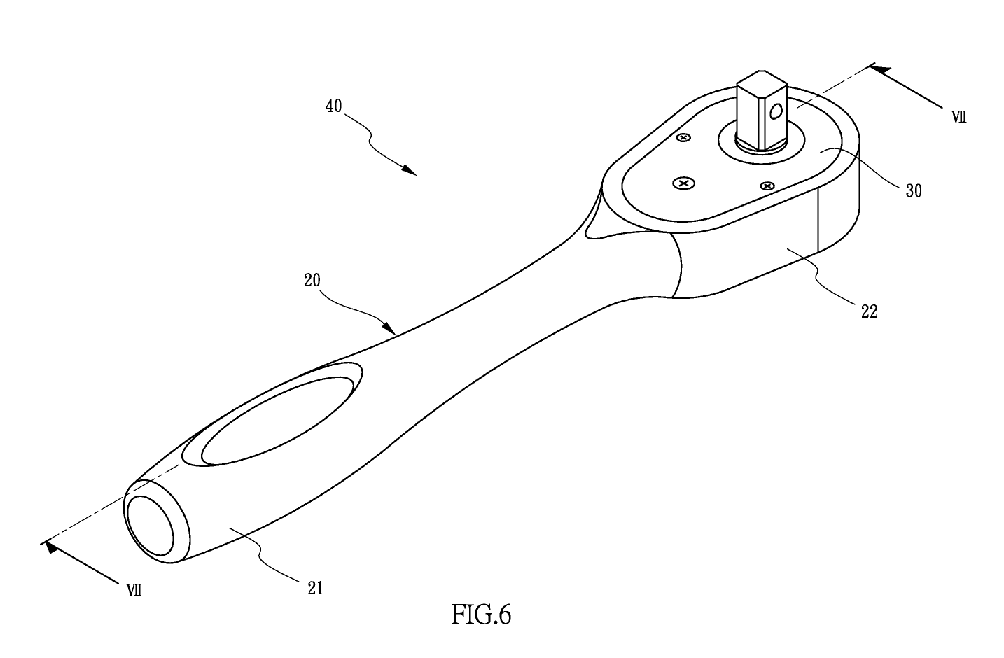

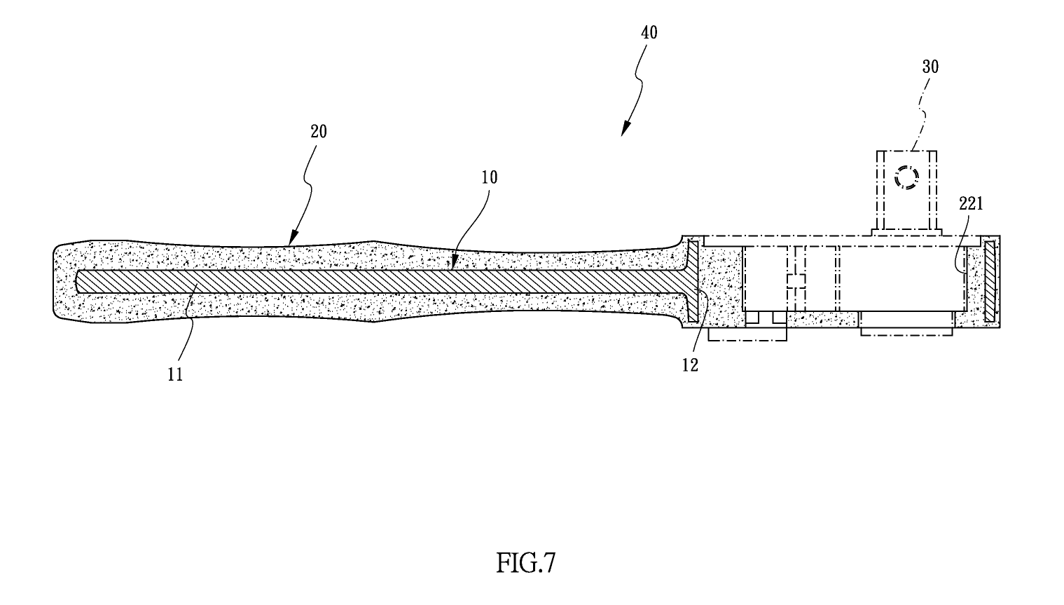

A step of assembly. As shown in FIGS. 6 and 7, a driving member 30 is assembled in the installation hole 221 of the driving head 22, and the driving member 30 is positioned in the installation hole 221 by using fixing members 31 so as to obtain a final product 40.

The base part 10 is made by hard material so as to have better strength, and the plastic is coated on the base part 10 to provide better grip feature. The driving member 30 is also made by hard material and can be a ratchet driving member which is rotated relative to the driving head 22 to output torque.

The steps allow the manufacturing cost of the final products 40 to be reduced about 25%-40%. The present invention has no sintering, powder metallurgy, heat treatment and hot forging required so as to save the manufacturing cost.

While we have shown and described the embodiment in accordance with the present invention, it should be clear to those skilled in the art that further embodiments may be made without departing from the scope of the present invention.

What is claimed is:

1. Manufacturing steps for manufacturing a hand tool, comprising:
a step of setting a base part: a baes part made by hard material being set and having a handle end and a driving end;
a step of molding: coating plastic to the base part by way of plastic injection molding to form the base part into an initial product which has a handle portion and a driving head, the handle portion located corresponding to the handle end, the driving head located corresponding to the driving end, an installation hole defined through the driving head;
a step of coating: electro-coating outer surface of the plastic of the initial produce, and
a step of assembly: assembling a driving member in the installation hole, the driving member being positioned in the installation hole by using fixing members so as to obtain a final product.
